(19) United States
(12) Patent Application Publication
(10) Pub. No.: US 2016/0271969 A1
(43) Pub. Date: Sep. 22, 2016

(54) IMAGE FORMING APPARATUS, RETRANSFER PRINTER AND IMAGE FORMING METHOD

(71) Applicant: JVC KENWOOD CORPORATION, Yokohama-shi (JP)

(72) Inventor: Keiji IHARA, Yokohama-shi (JP)

(21) Appl. No.: 15/000,758

(22) Filed: Jan. 19, 2016

(30) Foreign Application Priority Data
Mar. 19, 2015 (JP) 2015-056008

(51) Int. Cl. B41J 2/325

(52) U.S. Cl. CPC B41J 2/325

(57) ABSTRACT

An ink ribbon conveyance mechanism conveys an ink ribbon including color ink layers. A transfer film conveyance mechanism conveys a transfer film on which transfer frames are formed at a predetermined pitch in a longitudinal direction and demarcated by frame marks having light transmissivity lower than that of the rest of the transfer film. A line sensor is arranged to extend in a width direction of the transfer film across end portions of the frame marks in the width direction. A thermal head is brought into press (contact with a platen roller with the ink ribbon and transfer film interposed in between. When forming color images on a selected one of the transfer frames, the controller adjusts positions of the images to be formed on the selected transfer frame in the width direction based on light-reception information outputted from the line sensor.

### CROSS REFERENCE TO RELATED APPLICATION

This application is based upon and claims the benefit of priority under 35 U.S.C. §119 from Japanese Patent Application No. 2015-056008, filed on Mar. 19, 2015, the entire contents of which are incorporated herein by reference.

### BACKGROUND

The present disclosure relates to an image forming apparatus, a retransfer printer and an image forming method.

An image forming apparatus, which is configured to form a multi-color image in such a way that multiple color inks are transferred by sublimation or fusion using a thermal head onto the same transfer area on a belt-shaped transfer film from an ink ribbon on which a group of multiple color ink layers is repeatedly applied in a longitudinal direction, is known.

Japanese Patent No. 4337582 (Patent Document 1) describes a retransfer printer including this type of image forming apparatus. The ink ribbon used in the printer described in Patent Document 1 includes ink layers of four colors, that is, yellow, magenta, cyan and black.

The printer forms a multi-color image by: placing the ink layers of the ink ribbon on an intermediate transfer film; bringing a thermal head into press contact with an opposite surface of the ink ribbon from the ink layers while moving the ink ribbon in a longitudinal direction; and superposing and transferring color inks one after another onto the same transfer area on the intermediate transfer film.

For each color, the printer performs an operation of releasing the thermal head, an operation of rewinding the intermediate transfer film by one frame, a cue operation on the intermediate transfer film, and an operation of bringing the thermal head into press contact, in this sequence.

Thus, the printer performs the cue operation on the intermediate transfer film four times (performing the rewinding operation on the intermediate transfer film three times) in order to form one multi-color image using the four color inks.

As shown in Patent Document 1, in each group of ink layers on the ink ribbon, the leading end position of the yellow ink layer which is a first transfer color in the group is provided with a cue mark for performing the cue operation on the group. In addition, in the intermediate transfer film, the leading end position of each frame is provided with a frame mark for performing a cue operation on the frame.

The printer described in Patent Document 1 includes a retransfer apparatus configured to perform a retransfer operation to transfer the color image, which is formed on the intermediate transfer film, onto a retransfer material again, in addition to the image forming apparatus configured to perform the foregoing image forming operation.

The retransfer printer is known to have a case where the ink ribbon and the intermediate transfer film shift sideways (are displaced from their proper conveyance positions in the width direction) during their conveyance because of their thin-ness and other factors.

If the sideways shift occurs during the conveyance, multiple color images are misregistered in the width direction in superposing and transferring the multiple colors. This makes it difficult to obtain a high-quality image.

Japanese Patent Application Publication No. 2005-238666 (Patent Document 2) discloses that a weight for giving tension to the ink ribbon or the intermediate transfer film is provided to a printer to prevent the sideways shift.

Visual sense recognizes the positional shifts of color images as the colors are misregistered. For this reason, the state in which the positions of color images shift will be also referred to as “misregistered.”

### SUMMARY

The method described in Patent Document 2 needs to add the cylindrical weight, and involves an obvious cost increase. In addition, although the method may be useful to prevent the occurrence of a large sideways shift, it is difficult for the method to prevent the occurrence of a sideways shift involving a small positional shift in the order of a pixel level, and accordingly, it is difficult to form a recently-demanded high-resolution image.

For this reason, an idea for enabling the formation of the high-resolution image while minimizing the cost increase has been requested.

A first aspect of the embodiments provides an image forming apparatus including: a platen roller; a thermal head configured to be brought into or out of contact with the platen roller in a relative movement; an ink ribbon conveyance mechanism configured to convey an ink ribbon including a plurality of color ink layers; a transfer film conveyance mechanism configured to convey a transfer film on which a plurality of transfer frames are formed at a predetermined pitch in a longitudinal direction and demarcated by frame marks having light transmissivity lower than that of another part of the transfer film; a line sensor arranged to extend in a width direction of the transfer film across end portions of the frame marks in the width direction; and a controller.

The controller is configured to, when forming color images on a selected one of the transfer frames, by making the ink ribbon conveyance mechanism and the transfer film conveyance mechanism respectively convey the ink ribbon and the transfer film such that the color ink layers on the ink ribbon sequentially face the selected transfer frame on the transfer film, and by bringing the thermal head into press contact with the platen roller with the ink ribbon and the transfer film interposed in between, adjust positions of the images to be formed on the selected, transfer frame, in the width direction based on light-reception information outputted from the line sensor.

A second aspect of the embodiments provides a retransfer printer including: the above-described image forming apparatus; and a retransfer apparatus configured to retransfer the images, transferred onto the transfer frame by the image forming apparatus, onto a transfer material.

A third aspect of the embodiments provides an image forming method including: detecting positions of an end portion of a frame mark in a width direction on a transfer film, on which a plurality of transfer frames are formed at a predetermined pitch in a longitudinal direction, and are demarcated by frame marks having light transmissivity lower than another part of the transfer film, based on light-reception information outputted from a line sensor arranged to extend across the end portion in the width direction; and adjusting positions of color images to be formed by superposing and transferring a plurality of color ink images onto one of the transfer frames, in the width direction based on the detected positions of the end portion of the frame mark in the width direction.

### BRIEF DESCRIPTION OF THE DRAWINGS

FIG. 1 is a diagram showing a retransfer printer PR including an image forming apparatus 51 according to at least one embodiment.

FIG. 2 is a block diagram showing a configuration of the printer PR.

FIG. 3A is a plan view showing an ink ribbon 11 used in the image forming apparatus 51.

FIG. 3B is a schematic side view showing the ink ribbon 11 used in the image forming apparatus 51.

FIG. 4A is a plan view showing an intermediate transfer film 21 used in the image forming apparatus 51.

FIG. 4B is a schematic side view showing the intermediate transfer film 21 used in the image forming apparatus 51.

FIG. 5 is a diagram for explaining a press-contact state of a thermal head 16 included in the image forming apparatus 51.

FIG. 6 is a block diagram showing a configuration of the thermal head 16.

FIG. 7 is a schematic diagram for explaining how a frame sensor 25 included in the image forming apparatus 51 is arranged.

FIG. 8 is a diagram for explaining a positional relationship between the thermal head 16 and the frame sensor 25.

FIG. 9 is a block diagram showing a detailed configuration of a controller CT in the image forming apparatus 51.

FIG. 10 is a diagram for explaining a cue operation performed by the image forming apparatus 51.

FIG. 11 is schematic diagram for explaining a positional relationship between the frame sensor 25 and the intermediate transfer film 21 shifting sideways.

FIG. 12 is a flowchart for explaining a procedure until a CPU 81 causes judgment to be made on correction amount determination for a cue operation to be performed by the image forming apparatus 51.

FIG. 13 is a schematic diagram for explaining a transfer data buffer 62 included in the controller CT.

FIG. 14 is a diagram for explaining the state where a yellow image Y(1) is transferred onto a frame F1 on the intermediate transfer film 21.

FIG. 15 is a diagram for explaining a cue operation for superposing and transferring a magenta image onto the yellow image Y(1) formed on the frame F1.

FIG. 16 is a diagram for explaining a color image P(1) formed on the frame F1.

### DETAILED DESCRIPTION

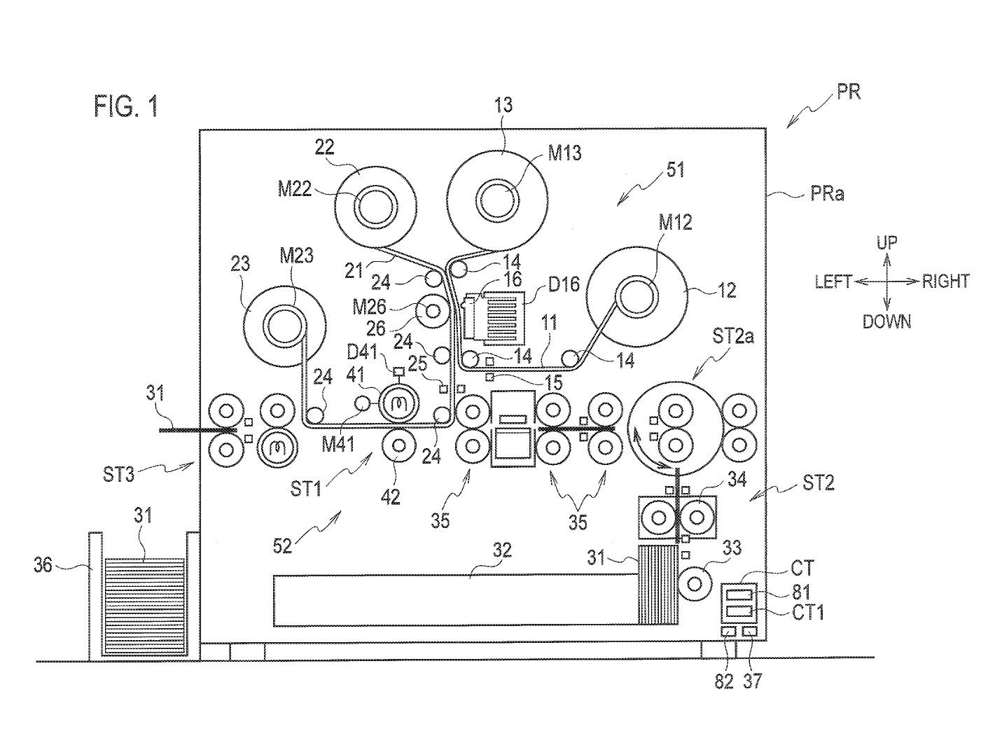

Referring to FIGS. 1 to 16, descriptions will be provided for an image forming apparatus 51 according to at least one embodiment.

As shown in FIG. 1, the image forming apparatus 51 is contained in a housing PRa of a printer PR. The printer PR is a retransfer printer designed to perform retransfer printing, using an intermediate transfer film 21. The printer PR is a so-called card printer.

A detachable supply reel 12 and a take-up reel 13 for an ink ribbon 11 can be attached to the image forming apparatus 51.

After thus attached, the supply reel 12 and the take-up reel 13 rotate by being driven by a motor M12 and a motor M13. The motor M12 and the motor M13 constitute an ink ribbon conveyance mechanism. The rotational speeds and rotational directions of the motors M12 and M13 are controlled by a controller CT installed in the image forming apparatus 51.

Guided by multiple guide shafts 14, the ink ribbon 11 is suspended along a predetermined travelling route between the supply reel 12 and the take-up reel 13.

An ink ribbon sensor 15 for a cue operation is disposed in the middle of the travelling route of the ink ribbon 11.

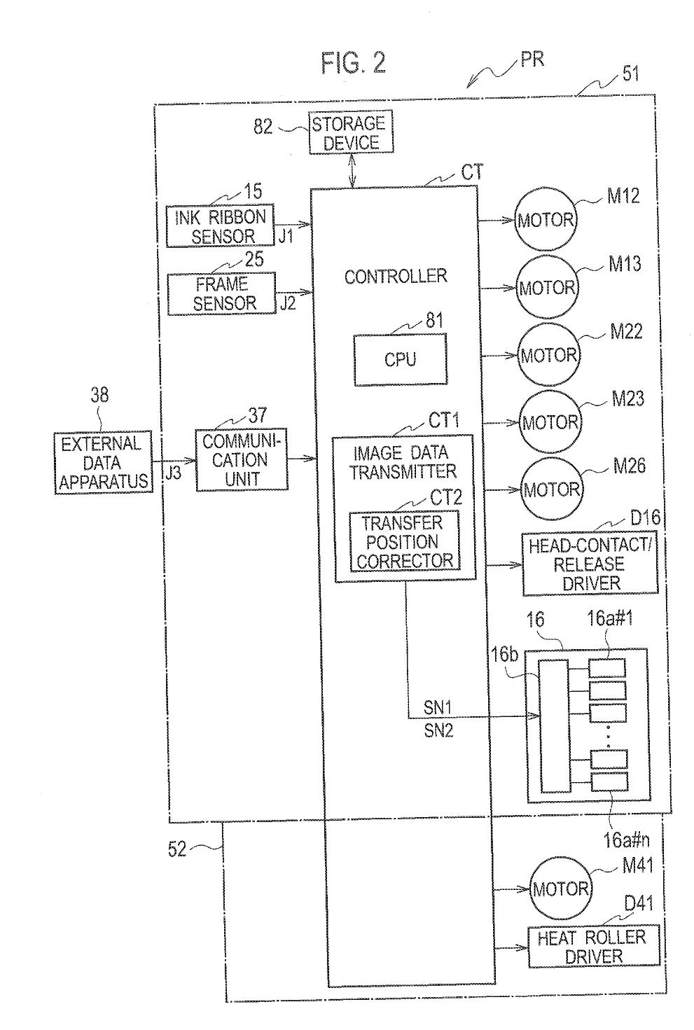

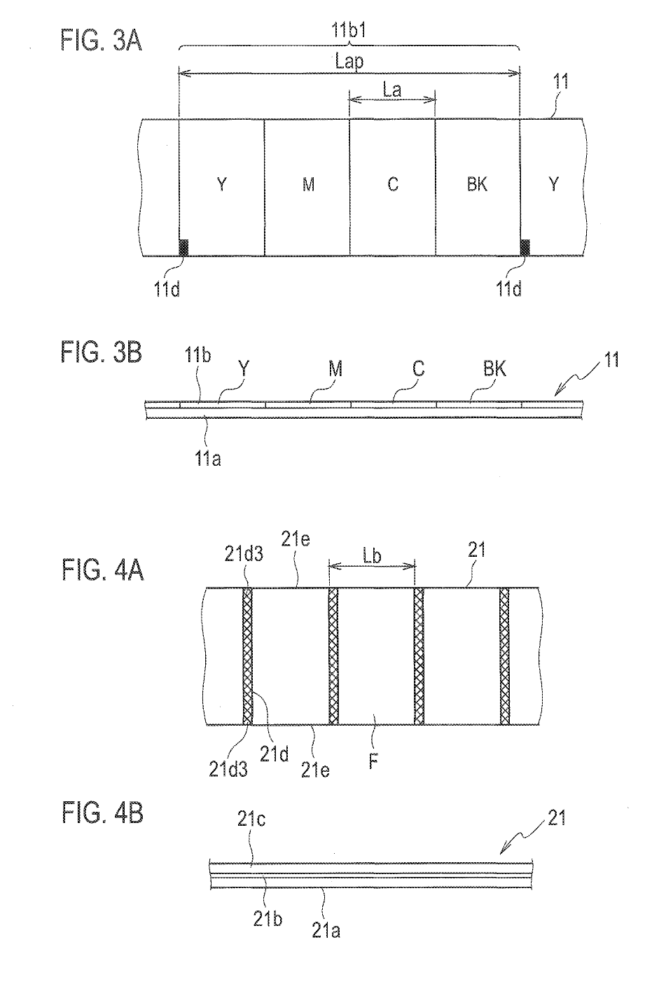

The ink ribbon sensor 15 detects a cue mark 11d (see FIGS. 3A and 3B) on the ink ribbon 11, and sends ribbon mark detection information J1 (see FIG. 2) to the controller CT.

A thermal head 16 is disposed along the travelling route of the ink ribbon 11 between the ink ribbon sensor 15 and the take-up reel 13.

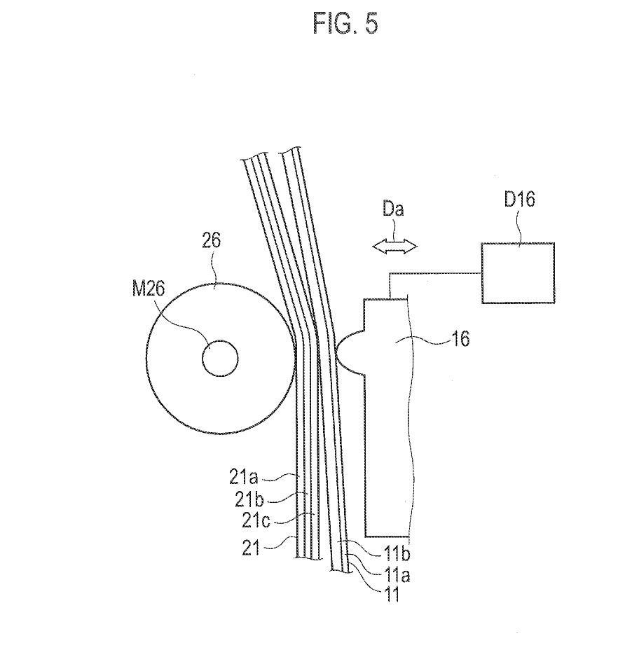

The thermal head 16 comes into and goes out of contact with a ribbon base 11a-side surface (see FIGS. 3A and 3B) of the suspended ink ribbon 11 (in directions indicated with a left-right double arrow Da in FIG. 5).

Under control or the controller CT, a head-contact/release driver D16 makes the thermal head 16 come into and go out of contact with the ink ribbon 11.

A detachable supply reel 22 and a take-up reel 23 for the intermediate transfer film 21 is attached to a part of the image forming apparatus 51 which is on the left from the loaded ink ribbon 11 in FIG. 1.

After being attached, the supply reel 22 and the take-up reel 23 rotate by being driven by a motor M22 and a motor M23. The motor M22 and the motor M23 constitute a transfer film conveyance mechanism. The rotational speeds and rotational directions of the motors M22 and M23 are controlled by the controller CT.

The intermediate transfer film 21 is a transfer film on which inks are transferred from the ink ribbon 11. This transfer film is referred to as the intermediate transfer film 21, because the transfer film serves as an intermediate transfer material before retransfer in the printer PR.

Guided by multiple guide shafts 24, the intermediate transfer film 21 is suspended along a predetermined travelling route between the supply reel 22 and the take-up reel 23.

A frame sensor 25 for a cue operation is disposed in the middle of the travelling route of the intermediate transfer film 21.

The frame sensor 25 detects a frame mark 21d (see FIGS. 4A and 45) on the intermediate transfer film 21, and sends frame mark detection information J2 (see FIG. 2) to the controller CT. Detailed descriptions will be provided for the frame sensor 25 and the frame mark detection information J2 later.

The ink ribbon 11 and the intermediate transfer film 21 are approximately 0.01 mm in thickness, for example. In FIG. 1, the ink ribbon 11 and the intermediate transfer film 21 are represented by exaggeratedly thick lines for the purpose of facilitating understanding.

A platen roller 26 configured to rotate by being driven by a motor M26 is disposed along the travelling route of the intermediate transfer film 21 between the frame sensor 25 and the supply reel 22. The rotational speed and rotational direction of the motor M26 is controlled by the controller CT.

As shown in FIG. 5, the thermal head 16 comes into and goes out of contact with the ink ribbon 11 in accordance with the contact/release operation of the head-contact/release driver D16.

To put it in detail, the thermal head 16 presses the ink ribbon 11 against the platen roller 26. The thermal head 16 moves back and forth between a press-contact state and a release state. In this respect, when in the press-contact state (a state illustrated in FIG. 5), the thermal head 16 brings the intermediate transfer film 21 and the ink ribbon 11, as interposed between the thermal head 16 and the platen roller 26, in press contact with each other. When in the release state (a state illustrated in FIG. 1), the thermal head 16 stays away from the ink ribbon 11. The transfer, albeit described later, is performed while the thermal head 16 is in the press-contact state.

The ink ribbon 11 and the intermediate transfer film 21 are designed such that while the thermal head 16 is in the release state, the ink ribbon 11 and the intermediate transfer film 21 can be independently wound forward by the take-up reels 13 and 23, and wound back by the supply reels 12 and 22, in accordance with the operations of the motors M12 and M13, as well as the motors M22 and M23.

The ink ribbon 11 and the intermediate transfer film 21 are designed such that while the thermal head 16 is in the press-contact state, the ink ribbon 11 and the intermediate transfer film 21 can move to the supply reels or take-up reels, as being in close contact with each other. The configuration is made in such a way that based on the control of the controller CT, the ink ribbon 11 and the intermediate transfer film 21 move in accordance with the rotations of the supply reels 12 and 22, the take-up reels 13 and 23, and the platen roller 26 driven by the motors M12, M13, M22, M23 and M26.

The controller CT includes a CPU 81 and an image data transmitter CT1. The image data transmitter CT1 includes a transfer position corrector CT2 (see FIG. 2). The transfer position corrector CT2 determines a transfer position in a frame F (described later) by reflecting correction. Image data SN1 and a control signal SN2 (see FIG. 2) for transferring an image to the thus-determined transfer position are transmitted by the image data transmitter CT1 to a head driver 16b of the thermal head 16.

The image forming apparatus 51 includes a communication unit 37 to make communications with storage device 82 and the outside. The storage device 82 stores operation programs for executing the overall operations of the image forming apparatus 51, transfer image information J3 (see FIG. 2) which is information on an image to be transferred, and the like. The contents stored in the storage device 82 are referred to by the CPU 81 as necessary.

As shown in FIG. 2, the operation programs and the transfer image information 33 are supplied from an external data apparatus 38 and the like to the controller CT via the communication unit 37, and are stored in the storage device 82.

As shown in FIGS. 3A and 3B, the ink ribbon 11 includes a belt-shaped ribbon base 11a and an ink layer 11b applied and formed on the ribbon base 11a.

The ink layer 11b is formed by an ink group 11b1 repeatedly applied onto the ribbon base 11a. The ink group 11b1 is a group of color ink layers arranged in the longitudinal direction of the ink ribbon 11, and each representing one of multiple colors (four colors in this example). The longitudinal direction of the ink ribbon 11 agrees with the conveyance direction of the ink ribbon 11.

The ink group 11b1 includes a yellow ink layer Y, a magenta ink layer K, a cyan ink layer C and a black ink layer BK, which are applied onto the ribbon base 11a in a longitudinal direction in this order.

Each color ink is a sublimation ink. The black ink may be a fusion ink.

The cue mark lid is formed in an edge portion of the yellow ink layer Y. The edge portion is in a boundary area between the yellow ink layer Y and the contiguous black ink layer BK.

The ink layers Y, M, C and BK have the same longitudinal length La. For this reason, a pitch Lap of each ink group 11b1 is four times the length La.

The position of the ink ribbon sensor 15 is designed in such a way that when the ink ribbon sensor 15 detects the cue mark lid, a press-contact position Ph1 (see FIG. 8) of the thermal head 16 is located at a transfer start position (a head-side position in a movement direction for transfer) of the yellow ink layer Y.

Therefore, the length of the travelling route from the press-contact position Ph1 to the detection position of the ink ribbon sensor 15 is an integer multiple of the pitch Lap.

As shown in FIGS. 4A and 4B, the intermediate transfer film 21 includes: a belt-shaped film base 21a; and a detachment layer 21b and a transfer image receiving layer 210 laminated on the film base 21a.

The width of the film base 21a is equal to that of the ribbon base ha of the ink ribbon 11.

The frame mark 21d is formed on the film base 21a or the transfer image receiving layer 21c repeatedly at a predetermined pitch Lb in the longitudinal direction of the intermediate transfer film 21. The longitudinal direction of the intermediate transfer film 21 agrees with the conveyance direction of the intermediate transfer film 21.

The frame mark 21d is formed across the full width of the intermediate transfer film 21. Specifically, in this example, the mark side end portions 21d3 of the frame mark 21d in the width direction coincide with side edge portions 21e of the film base 21a.

The frame mark 21d may be formed in such a way to reach at least one of side edge portions 21e of the intermediate transfer film 21.

The pitch Lb is equal to the length La of each of the ink layer Y, M, C, and BK (La=Lb).

Each of areas into which the intermediate transfer film 21 is divided at the pitch Lb forms the transfer frame F. The transfer frame F will be hereinafter referred to as a “frame F.” To recapitulate briefly, the frame mark 21d is provided to the boundary area of each frame F, and demarcates the frame F.

The position of the frame sensor 25 is designed such that when the frame sensor 25 detects the frame mark 21d, the press-contact position Ph1 of the thermal head 16 is located at the transfer start position of an arbitrary frame F.

It is most desirable that the press-contact position Ph1 agree with the transfer start position in the frame F which is in contact with the frame mark 21d detected by the frame sensor 25.

Detailed descriptions will be later provided for how the frame sensor 25 operates in order to detect the frame mark 21d.

In the image forming apparatus 51, the intermediate transfer film 21 and the ink ribbon 11 are suspended with the transfer image receiving layer 21c and the ink layer 11b directly facing each other, as shown in FIG. 5.

The transfer image receiving layer 21c has a property in which the transfer image receiving layer 21c receives the heat-sublimated inks from the ink layer 11b, and fixes the inks thereto. In a case where the inks in the black ink layers BK are fusion inks, the transfer image receiving layer 21c receives the heat-fused inks from the black ink layers BK, and fixes the inks thereto.

Thereby, when the thermal head 16 is in the press-contact state shown in FIG. 5, the inks are transferred to the transfer image receiving layer 21c from the ink layer 11b which is in press contact with the transfer image receiving layer 21c. Thus, a two-dimensional image is formed on the transfer image receiving layer 21c by the movement, of the ink ribbon 11 and the intermediate transfer film 21 as being in press contact with each other. The inks are transferred in accordance with a heat pattern which corresponds to the image data supplied to the thermal head 16.

The image forming apparatus 51 which has been described in detail is designed to be capable of making the thermal head 16 press the ink ribbon 11 and the intermediate transfer film 21, set by the user, into close contact with each other; and moving the ink ribbon 11 and the intermediate transfer film 21 while in close contact with each other.

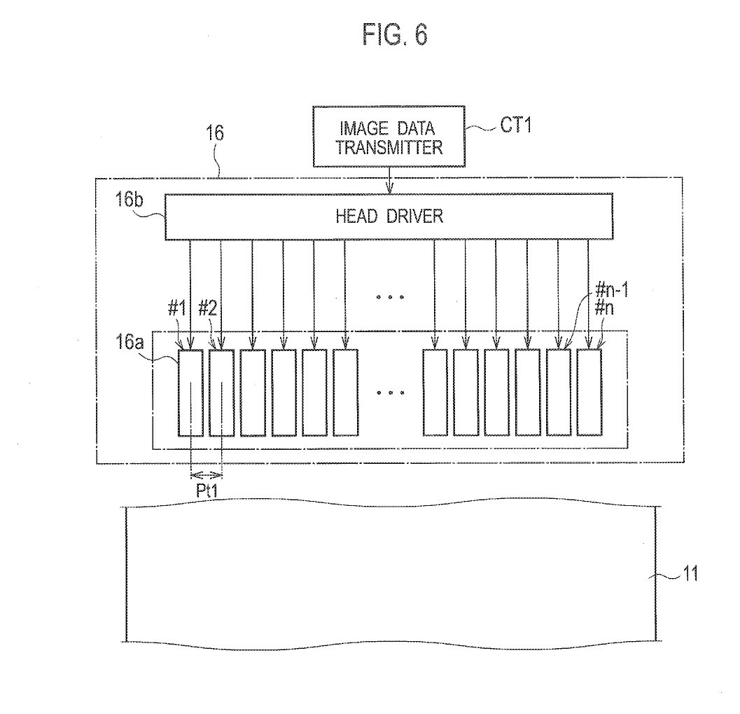

As shown in FIG. 6, the thermal head 16 includes n heating resistors 16a which are arranged at a predetermined pitch Pt1 in the width direction of the ink ribbon 11, and which are respectively numbered from #1 to #n (n: an integer equal to 2 or more). Three hundred heating resistors 16a are arranged side-by-side per inch, for example.

The thermal head 16 further includes a head driver 16b configured to electrify the multiple heating resistors 16a independently from one another in accordance with the image data SN1 and the control signal SN2.

Based on the image data SN1 to be transferred and the control signal SN2 transmitted from the image data transmitter CT1, the head driver 16b electrifies the multiple heating resistors 16a individually.

Usually, it is not all of the n heating resistors 16a but m number of consecutive heating resistors 16a (m is an integer equal to or more than 1 and smaller than n) that are used to form images, keeping reserves at the both ends in the side-by-side arrangement direction.

Specifically, out of the multiple (n) heating resistors 16a arranged side-by-side, the (n-m) heating resistors 16a are reserved, and are not used for the image formation. Furthermore, from the multiple (n) heating resistors 16a, the m consecutive heating resistors 16a are selected by excluding the other heating resistors 16a from at least one of the two ends.

Using m×Lna dots (the number of widthwise-arranged dots times the number of vertically-arranged dots), the image is formed on the intermediate transfer film 21 which is an image-formation material. In this respect, LNa denotes the number of vertically-arranged lines representing the image to be transferred, and corresponds to the number of lines which can be selected to be electrified or not. In the embodiment, the vertical direction of the image agrees with the conveyance direction of the ink ribbon 11 and the conveyance direction of the intermediate transfer film 21.

For example, when the printer PR forms a 300-dpi image on an 86 mm×54 mm card which is a retransfer material, m is set at approximately 1000, and LNa is set at approximately 600. When the 300-dpi image is formed thereon, the pitch Pt1 between each two of the heating resistors 16a is set at approximately 85 μm.

The image forming apparatus 51 puts the thermal head 16 into the press-contact state, and heats the heating resistors 16a of the thermal head 16, depending on the necessity based on the image data on the image to be transferred, while moving the ink ribbon 11 and the intermediate transfer film 21 as being in close contact with each other. Thereby, the image forming apparatus 51 transfers the inks from the ink layer 11b of the ink ribbon 11 onto the transfer image receiving layer 21c of the intermediate transfer film 21.

Thereby, the image forming apparatus 51 can transfer desired images on the frames on the transfer image receiving layer 21c. A procedure for the image forming operation will be described in detail later.

Returning back to FIG. 1, the printer PR includes a retransfer apparatus 52 configured to retransfer a part of the image (hereinafter referred to as an “intermediate image” as well), which the image forming apparatus 51 has formed on the transfer image receiving layer 21c of the intermediate transfer film 21, onto another transfer material.

In this example, the transfer material is a card 31. In FIG. 1, the cards 31 in the middle of conveyance are each represented by a thick line.

The retransfer apparatus 52 shares the controller CT with the image forming apparatus 51.

The retransfer apparatus 52 includes: a retransfer unit ST1 provided along the travelling route of the intermediate transfer film 21 between the platen roller 26 and the take-up reel 23; a supply unit ST2 configured to supply the card 31 to the retransfer unit ST1; and a delivery unit ST3 configured to deliver the card 31 which has passed through the retransfer unit. ST1.

The retransfer unit 311 includes: a heat roller 41 configured to be rotated by a motor M41; a facing roller 42 disposed facing the heat roller 41; and a heat roller driver D41 configured to bring the heat roller 41 into and out of contact with the facing roller 42.

The supply unit ST2 includes an orientation changing unit ST2a configured to turn the card 31 at 90 degrees so as to change the orientation of the card 31 from the vertical orientation to the horizontal orientation while keeping the card 31 held by the orientation changing unit ST2a.

The supply unit ST2 further includes a pickup roller 33 configured to rotate so as to pick up a card 31 rightmost in FIG. 1 from multiple cards 31 which are loaded vertically in a stacker 32.

The supply unit S12 further includes: a pair of feeding rollers 34 configured to feed the card 31, picked up by the pickup roller 33, to the orientation changing unit ST2a disposed above the feeding rollers 34 while holding the card 31 between the feeding rollers 34; and multiple pairs of conveyance rollers 35 configured to convey the card 31, whose orientation has been changed by the orientation changing unit ST2a to the horizontal orientation, to the retransfer unit ST1 leftward.

The operation of the motor M41 is controlled by the controller CT. In addition, the pickup roller 33, the feeding rollers 34, and the conveyance rollers 35 rotate by being driven by their motors, albeit not illustrated, under the control of the controller CT.

The retransfer apparatus 52 vertically picks up one card 31 from the stacker 32 by use of the supply unit ST2, and changes the orientation of the card 31 to the horizontal orientation by use of the orientation changing unit ST2a, thereafter conveying and supplying the card 31 to the retransfer unit ST1.

In accordance with the drive of the motor P41, the card 31 moves toward the delivery unit ST3 through the retransfer unit ST1, where the card 31 and the intermediate transfer film 21 are brought into press contact with each other, and are held between the heated heat roller 41 and the facing roller 42, by the operation of the heat roller driver D41. The transfer image receiving layer 21c of the intermediate transfer film 21 is in press contact with the card 31.

In the process of this press-contact movement, a partial area of the intermediate image which the image forming apparatus 51 has formed on the transfer image receiving layer 21c is transferred to the card 31. That is, an image is formed on the front surface of the card 31 by retransfer.

The card 31 onto which the image has been retransferred is conveyed to the delivery unit ST3, and are stacked and contained in a stocker 36 outside the printer PR.

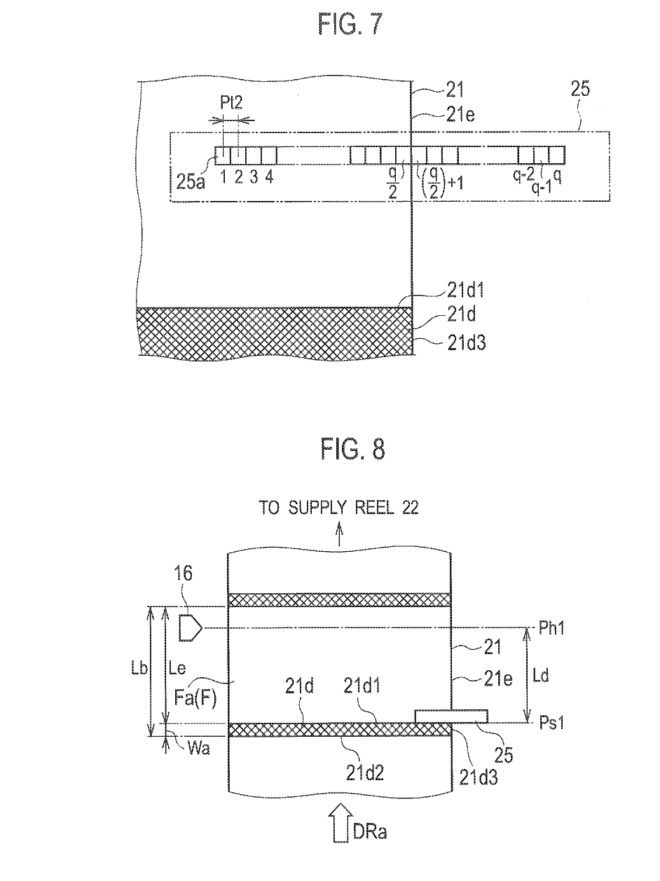

Next, referring to FIGS. 7 and 8, detailed descriptions will be provided for the frame sensor 25.

The frame sensor 25 is an optical sensor including a set of an emission unit configured to emit light and a light receiving unit configured to receive the light.

The frame sensor 25 uses a line sensor for its light receiving unit. As shown in FIG. 7, multiple light receiving sensors 25a are arranged in such an orientation that their side-by-side arrangement direction agrees with the width direction of the intermediate transfer film 21. FIG. 7 shows an example where the frame sensor 25 includes q light receiving sensors 25a, where q is an even number in this case.

The frame sensor 25 is configured such that the emission unit emits light and the light receiving unit receives the light which has passed through the intermediate transfer film 21.

The unused intermediate transfer film 21 has a light transmission property. As a light blocking part, the frame mark 21d is provided to the intermediate transfer film 21. For this reason, the frame mark 21d can be detected based on the difference in the amount of light received by the light receiving sensors 25a (in this case, whether or not the light is received) between the unused intermediate transfer film 21 and the frame mark 21d.

A pitch Pt2 between each two of the light receiving sensors 25a of the frame sensor 25 is set at half or less than the pitch Pt1 between each two of the heating resistors 16a. The pitch Pt2 is 5 μm, for example.

The amounts of light received by the respective light receiving sensors 25a are sequentially read, for example, from first to q-th light receiving sensors 25a, and are associated with the respective side-by-side arrangement numbers 1 to p. Thereafter, as the frame mark detection information J2, the thus-associated amounts of light received thereby are sent to the controller CT (see FIG. 2).

The arrangement position of the frame sensor 25 in the width direction of the intermediate transfer film 21 is adjusted and set such that when the intermediate transfer film 21 is in a reference conveyance position without shifting sideways, the position of one side edge portion 21e of the intermediate transfer film 21 in the width direction is located in a central position of the sensor line. That is, the side edge portion 21e in the width direction is set at a boundary position between a (q/2)-th light receiving sensor 25a and a [(q/2)+1]-th light receiving sensor 25a.

In a case where the frame mark 21d is formed in such a way to reach only one of the side edge portions 21e of the intermediate transfer film 21, the frame sensor 25 may be arranged extending across the side edge portion 21e which the frame mark 21d of the intermediate transfer film 21 is formed to reach.

As shown in FIG. 8, the arrangement position of the frame sensor 25 in the conveyance direction of the intermediate transfer film 21 is determined based on the relationship between the arrangement position thereof and the position of the thermal head 16.

To put it concretely, it is assumed that while the intermediate transfer film 21 is being wound back to the supply reel 22 (in a direction indicated, with a white arrow DRa), a boundary edge portion 21d1 which is the leading edge portion of the frame mark 21d in its movement direction reaches a detection position Ps1 of the frame sensor 25. The press-contact position Ph1 of the thermal head 16 is designed such that when the boundary edge portion 21d1 reaches the detection position Ps1, the press-contact position Ph1 thereof is located at a supply reel 22-side portion of a frame Fa contiguous to the frame mark 21d.

That is, a distance Ld in the conveyance direction between the press-contact position Ph1 of the thermal head 16 and the detection position Ps1 of the frame sensor 25 is set shorter than a distance Le obtained by subtracting a width Wa of the frame mark 21d in the conveyance direction from the pitch Lb of the frame F.

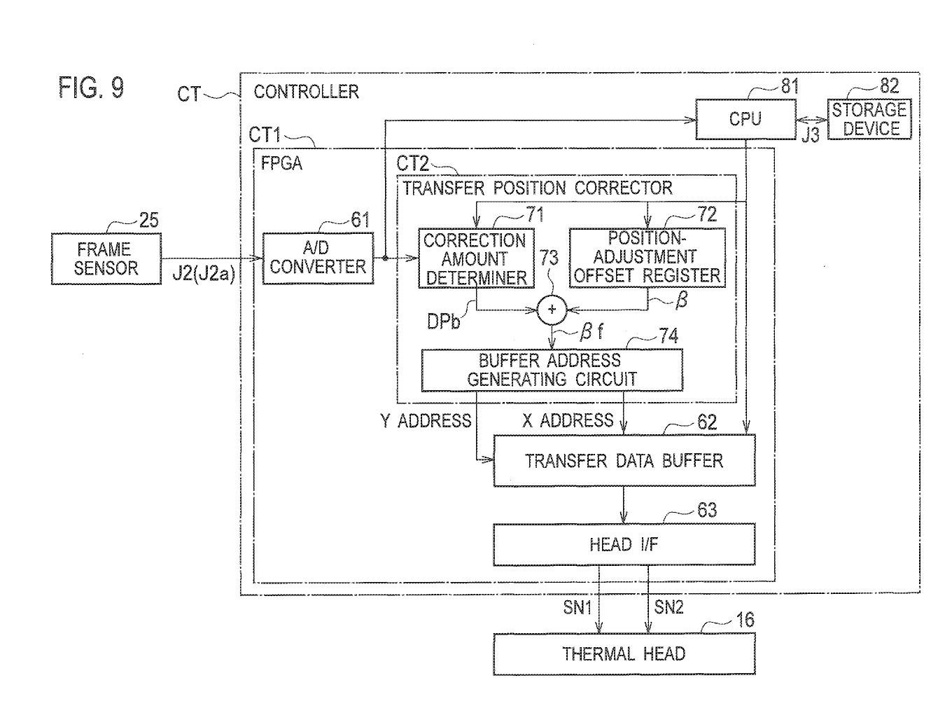

Detailed configuration of the controller CT is shown in FIG. 9.

In FIG. 9, the controller CT includes the CPU (Central Processing Unit) 81, and the image data transmitter CT1. For example, the image data transmitter CT1 uses an FPGA (Field Programmable Gate Array).

The image data transmitter CT1 includes an A/D converter 61, the transfer position corrector CT2, a transfer data buffer 62, and a head interface 63 (head I/F 63).

The transfer position corrector CT2 includes a correction amount determiner 71, a position-adjustment offset register 72, an adder 73, and a buffer address generating circuit 74.

The image data transmitter CT1 generates the image data SN1 for transferring the image to each frame F in the intermediate transfer film 21 and the control signal SN2 for controlling the operation of the thermal head 16. While the thermal had 16 is in the press-contact state, the image data transmitter CT1 supplies the image data SN1 and the control signal SN2 to the thermal head 16 at appropriate timing. Based on the frame mark detection information J2, the timing is determined by the controller CT as a whole.

The image data transmitter CT1 generates the image data SN1 based on the transfer image information J3.

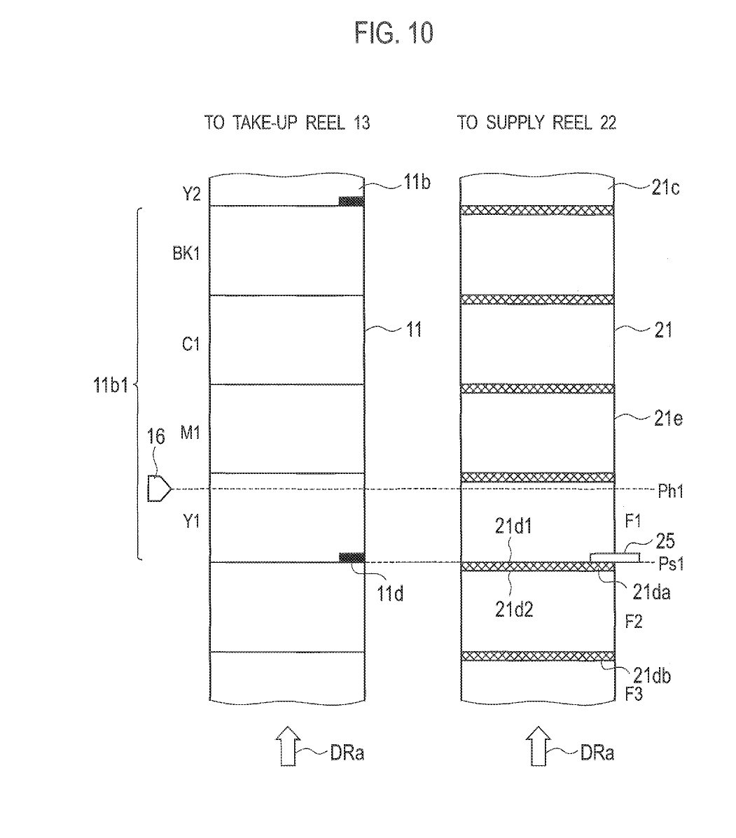

Next, referring mainly to FIGS. 10 to 16, descriptions will be provided for an image formation operation which the image forming apparatus 51 performs on the intermediate transfer film 21, and a method used in the operation, including a transfer position correction operation performed by the transfer position corrector CT2.

For each of the four colors, the image forming apparatus 51 performs a cue operation for the transfer operation.

To begin with, referring mainly to FIGS. 10 to 14, descriptions will be provided for a procedure with which a yellow image Y(1) is transferred onto a frame F1 which is a first frame on which to form an image in the intermediate transfer film 21.

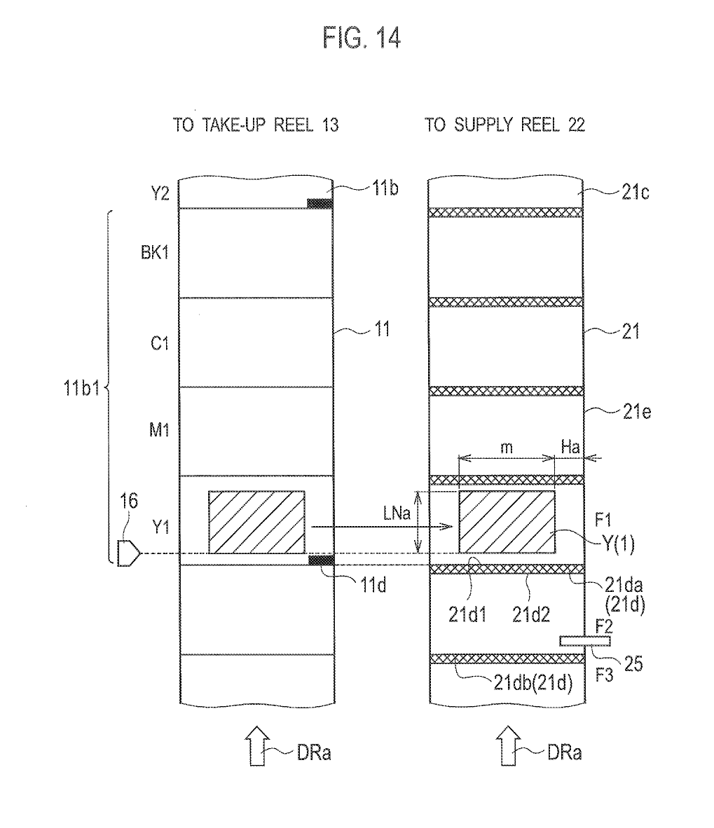

FIGS. 10 and 14 show the positions of the ink ribbon 11 and the intermediate transfer film 21 in relation to the thermal head 16 and the frame sensor 25 whose positions are determined relative to the conveyance direction of the intermediate transfer film 21 (and do not move), and transfer contents from the ink ribbon 11 to the intermediate transfer film 21. For the purpose of facilitating understanding, the surface of the ink layer 11b of the ink ribbon 11 and the transfer image receiving layer 21c of the intermediate transfer film 21, which are designed to be brought into close contact with and face each other for the transfer operation, are shown side-by-side in the left-right direction.

Furthermore, for the sake of explanation, either of numerical reference signs 1 and 2 is added to each ink group 11b1 to be supplied for the transfer. For example, Y1 to BK1 denote the yellow ink layer to the black ink layer in a first group.

Moreover, serial numbers starting with 1 are added to frames F in order of the image transfer. For example, F3 denotes a frame for a third image transfer.

In addition, the frame mark 21d in the boundary between the frames F1 and F2 is shown as the frame mark 21da.

Besides, images to be transferred are given parenthesized serial numbers. For example, an image M(1) means a first image (an image to be formed on the frame F1) among the images to be transferred using the magenta ink. Similarly, an image C(1) means a first image (an image to be formed on the frame F1) among the images to be transferred using the cyan ink.

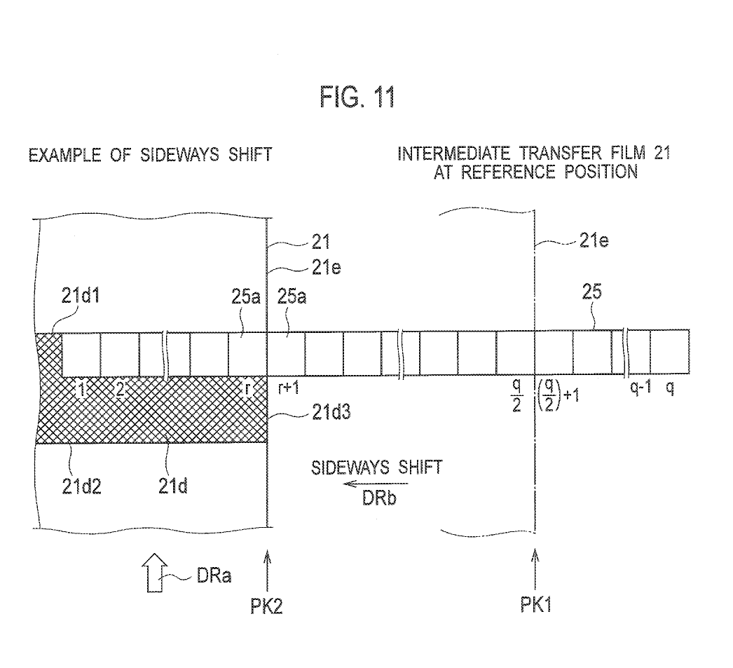

FIG. 11 is a schematic diagram for explaining the positional relationship between the frame sensor 25 and the intermediate transfer film 21 in terms of the width direction.

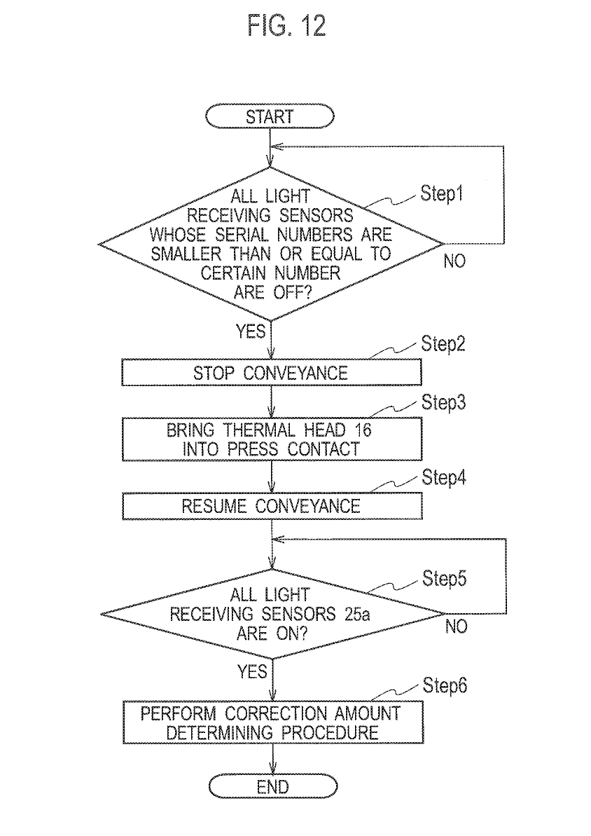

FIG. 12 is flowchart for explaining a procedure until the CPU 81 instructs the correction amount determiner 71 to perform a correction amount determining operation.

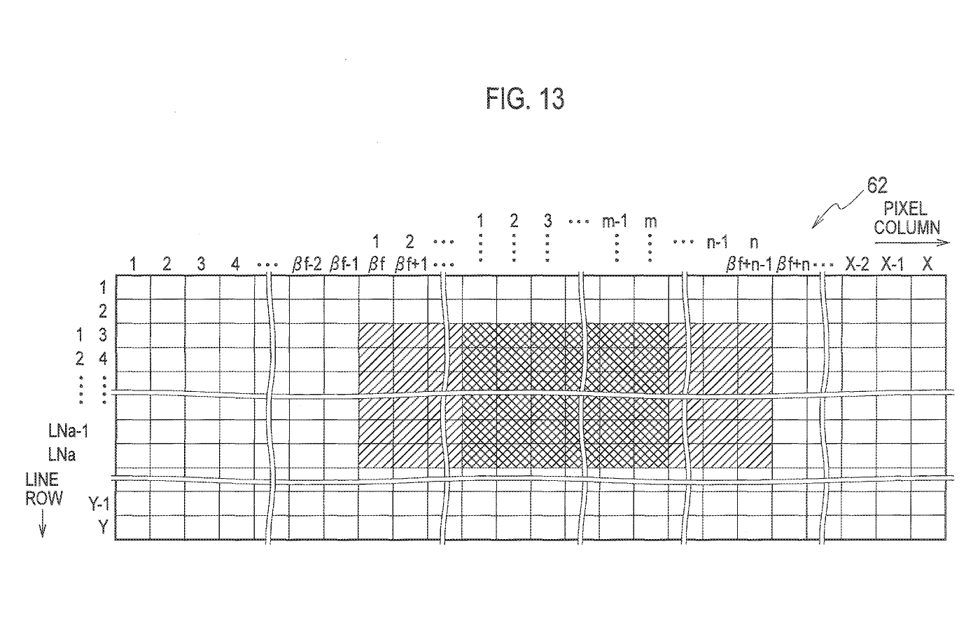

FIG. 13 is a schematic diagram for explaining an example of how image data is stored in the transfer data buffer 62.

First of all, as shown in FIG. 10, the controller CT aligns the yellow ink layer Y1 and the frame F1 together in the cue operation.

Based on the ribbon mark detection information J1 outputted from the ink ribbon sensor 15 (not illustrated in FIG. 10), the controller CT moves the ink ribbon 11 in order for the thermal head 16 to be located in the transfer start position of the ink layer Y1.

Based on the frame mark detection information J2, the controller CT controls the conveyance of the intermediate transfer film 21, as well as the contact/release operation of the thermal head 16.

To put it in detail, the controller CT winds the intermediate transfer film 21 hack to the supply reel 22 (see the white arrow DRa).

Once based on the frame mark detection information J2, the controller CT recognizes that the frame sensor 25 detects the frame mark 21da as a result that the boundary edge portion 21d1 between the frame mark 21da and the frame F1 reaches the detection position Ps1 of the frame sensor 25, the controller CT activates the head-contact/release driver D16, and thereby brings the thermal head 16 into the press-contact state from the release state.

As described above, the frame mark 21d is formed in such a way to reach at least one side edge portion 21e of the intermediate transfer film 21. The frame sensor 25 is a line sensor, and the frame mark 21d is arranged extending across the side edge portion 21e which the frame mark 21d reaches. The arrangement position of the frame sensor 25 is set in such a way that the reference conveyance position of the intermediate transfer film 21 in the width direction is located in the center of the multiple light receiving sensors 25a arranged in a line in the width direction.

In this respect, it is assumed that the intermediate transfer film 21 shifts sideways while a frame cue operation is being performed on the intermediate transfer film 21.

To put it concretely, it is assumed that as shown in FIG. 11, as a result of the sideway shift, the side edge portion 21e has shifted leftward in FIG. 11 from a reference position PK1 in the width direction (in a direction indicated with a white arrow DRb), and is located between an r-th light receiving sensor 25a and an (r+1)-th light receiving sensor 25a, where r<(q/2).

In this respect, it is assumed a case where while the side edge portion 21e is shifting sideways, the frame mark 21da of the intermediate transfer film 21 moving to the cue position in the direction indicated with the white arrow DRa is caught by the frame sensor 25. Before the frame mark 21da is caught by the frame sensor 25, all of the light receiving sensors 25a detect the presence of light (ON). When the frame mark 21da is caught by the frame sensor 25, first to r-th light receiving sensors 25a are blocked by the frame mark 21da from receiving light, and detects the absence of light (OFF). Meanwhile, (r+1)-th to q-th light receiving sensors 25a continue detecting the presence of light because these light receiving sensors 25a are not blocked by the frame mark 21da from receiving light.

As light-reception information J2a, information on ON/OFF of each of the first to q-th light receiving sensors 25a is transmitted being incorporated into the frame mark detection information J2 (see FIG. 9).

The A/D converter 61 converts the frame mark detection information J2 including the light-reception information J2a into digital data, and supplies the resultant digital data to the CPU 81 and the correction amount determiner 71.

In FIG. 12, based on the incoming light-reception information J2a, the CPU 81 determines whether or not all of the light receiving sensors 25a whose serial numbers are equal to or smaller than a certain number have turned from the ON state to the OFF state (Step 1).

If a result, Step 1 is negative (No), and the CPU 81 repeats the determination in Step 1.

In this respect, even when there is a light receiving sensor(s) in the OFF state, there may be cases where a result of the judgment is negative. Examples of the cases include: a case where only a light receiving sensor(s) 25a in the middle of the serial numbers is in the OFF state, or a case where the serial numbers of light receiving sensors 25a in the OFF state are not consecutive in a range smaller than or equal to the certain number with a light receiving sensor(s) 25a being in the ON state.

In these cases, the CPU 81 considers that the frame mark 21da has not blocked the light receiving sensor(s) 25a from the light and spot-shaped dirt or other factors have put the light receiving sensor(s) 25a into the OFF state. For this reason, the result of the judgment is negative.

If the result of the determination in Step 1 is positive (Yes), the CPU 81 stops the conveyance of the intermediate transfer film 21 (Step 2).

After stopping the conveyance of the intermediate transfer film 21, the CPU 81 activates the head-contact/release driver D16, and thereby brings the thermal head 16 into the press-contact state (Step 3).

Once the thermal head. 16 comes into the press-contact state, the CPU 81 restarts the conveyance of the intermediate transfer film 21 (Step 4).

The CPU 81 monitors the light-reception information J2a, and determines whether or not all of the first to q-th light receiving sensors 25a have turned ON again (Step 5).

If a result of the determination in Step 5 is negative (No), the CPU 81 continues monitoring the light-reception information J2a, and repeats the determination in Step 5. Furthermore, after the determination, the CPU 81 stores the light-reception information J2a having been used for the determination in the storage device 82. In this case, the information is stored by overwriting.

If the result of the determination in Step 5 is positive (Yes), the CPU 81 does not overwrite the light-reception information J2a already stored in the storage device 82, but instructs the transfer position corrector CT2 to obtain a correction amount based on the latest stored light-reception information J2a (Step 6).

Based on the instruction from the CPU 81, the transfer position corrector CT2 obtains the amount of correction to the transfer position.

Here, descriptions will be provided for details of the components which form the image data transmitter CT1 including the transfer position corrector CT2.

To begin with, as shown in FIG. 13, the transfer data buffer 62 is a matrix buffer configured to store the transfer data in a dot-matrix format.

To put it concretely, the transfer data buffer 62 is formed in an X×Y matrix obtained by multiplying together pixel buffer columns (hereinafter referred to as “pixel columns”) corresponding to X pixels in the width direction of the transfer image, and line buffer rows (hereinafter referred to as “line rows”) corresponding to Y lines in the vertical direction.

In this respect, X is set at a number greater than n which is the number of heating resistors 16a, and Y is set at a number greater than LNa which is the number of lines included in the transfer image.

Returning back to FIG. 9, offset information is stored in the position-adjustment offset register 72 in the transfer position corrector CT2.

The offset information includes an offset amount β for specifying to what pixel columns in the transfer data buffer 62 the n heating resistors 16a in the thermal head 16 should be assigned.

In a case where the n heating resistors 16a are to be assigned to n pixel columns starting with a b-th pixel column among the first to X-th pixel columns, b is stored as the offset amount β. The b is a positive integer which satisfies b≦(X−n) and represents the number of pixel columns.

The position-adjustment offset register 72 outputs the offset amount β to the adder 73.

The correction amount determiner 71 in the transfer position corrector CT2 obtains a correction amount DPb for correcting the transfer position in the width direction. The correction amount DPb is obtained as the number of heating resistors 16a.

Once receiving the instruction from the CPU 81, the correction amount determiner 71 obtains a differential DPa between “q/2” corresponding to the reference position PF1 of the side edge portion 21e (see FIG. 11) and “r” corresponding to a position PK2 to which the side edge portion 21e shifts in the width direction (see FIG. 11). In this respect, DPa=(q/2)−r.

Although representing an amount corresponding to the correction amount DPb which is used to correct the transfer position in the width direction because of the occurrence of the sideways shift, the differential DPa is a light receiving sensor 25a-based amount. To put it in more detail, the differential DPa is an amount (distance) in the unit of the pitch Pt2 of the light receiving sensors 25a. For this reason, the correction amount determiner 71 converts the differential DPa into a heating resistor 16a-based amount, more concretely, into an amount in the unit of the pitch Pt1 (the number) of the heating resistors 16a.

For example, if the pitch Pt1 of the heating resistors 16a is a times the pitch Pt2 of the light receiving sensors 25a, the correction amount. DPb is obtained as an integer part of a product of the differential DPa and 1/α.

That is, DPb=[DPa/α]=[(q/2=r)/2].

The correction amount determiner 71 outputs the thus-obtained correction amount DPb to the adder 73.

The adder 73 adds together the correction amount DPb coming from the correction amount determiner 71, and the offset amount 5 included in the offset information coming from the position-adjustment offset register 72, and sends the correction amount (the number of heating resistors 16a) obtained by the addition to the buffer address generating circuit 74 as a correction offset amount βf.

The buffer address generating circuit 74 determines addresses in the X×Y matrix buffer of the transfer data buffer 62 to which the data of the image to be transferred are stored, and supplies the thus-determined addresses to the transfer data buffer 62.

With regard to the line rows, their respective positions are set in advance with no correction process. In this example, a third line row is chosen as a first line of the transfer image, and the first to LNa-th lines of the transfer image are assigned to the third to [3+(LNa−1)]-th line rows.

With the pixel columns in the transfer data buffer 62, the correction offset amount βf coming from the adder 73 is applied to the pixel columns, and the transfer data buffer 62 stores the transfer data corresponding to the n heating resistors 16a.

To put it plainly, a βf-th pixel column is chosen for a first heating resistor 16a and the first to n-th heating resistors 16a are assigned to the βf-th to [βf+(n−1)]-th pixel columns. In FIG. 13, linear-hatched and cross-hatched buffers represent the βf-th to [βf+(n−1)]-th pixel columns.

Thereby, the heating resistors 16a corresponding to the image to be formed correspond to m consecutive pixel columns which are among the βf-th to [βf+(n−1)]-th pixel columns in the transfer data buffer 62. In FIG. 13, the cross-hatched buffers represent the m consecutive pixel columns.

As clear from FIG. 13, an area in which to store the image data in the pixel columns of the transfer data buffer 62 depends on the correction offset amount βf.

In this respect, the correction offset amount βf is a sum of the constant β and the correction amount DPb corresponding to the amount of shift attributable to the sideway shift of the intermediate transfer film 21. Because of this, the correction offset amount βf depends directly on the correction amount DPb. With this taken into consideration, the area necessary to store the image data in the transfer data buffer 62 is configured to move in the width direction so as to offset the amount of sideways shift.

In addition, the light-reception information J2a to be used for the correction is not one which is obtained at a first timing of the detection of the frame mark 21d by the frame sensor 25, but one which is obtained after the intermediate transfer film 21 with the thermal head 16 in press contact therewith is moved by an amount corresponding to the width Wa of the frame mark 21d in the conveyance direction.

While the thermal head 16 is not in press contact with the intermediate transfer film 21, the sideways shift is relatively unstable. However, once the intermediate transfer film 21 with the thermal head 16 in press contact therewith is conveyed over a slightest distance, the amount of sideways shift becomes stable, and immediately comes to represent a substantial amount of shift under the transfer condition.

For this reason, like in this case, it is desirable that the light-reception information J2a to be used to obtain the correction amount be one which is obtained from the last stage of the detection range of the frame mark 21da, that is to say, from the boundary edge portion 21da in the tailing end of the detection range thereof.

Descriptions will be returned to the transfer operation shown in FIG. 10.

It is assumed a case where while the thermal head 16 is in press contact with the ink ribbon 11, the press-contact movement of the intermediate transfer film 21 and the ink ribbon (in the direction indicated with the white arrow DRa) continues over a predetermined distance. At this time, the CPU 81 sends the transfer data stored in the transfer data buffer 62 to the head driver 16b of the thermal head 16 via the head I/F 63, depending on the pixel columns and line rows where the transfer data is stored.

The press-contact movement of the intermediate transfer film 21 and the ink ribbon 11 means to wind (forwardly convey) the ink ribbon 11 to the take-up reel 13, and to wind back (reversely convey) the intermediate transfer film, 21 to the supply reel 22.

Thereby, as shown in FIG. 14, the yellow image Y(1) is transferred onto the frame F1 on the intermediate transfer film 21. The transfer position of the image Y(1) in the width direction is a position reflecting the offset and correction of the positional shift of the intermediate transfer film, 21 in the width direction attributable to the sideways shift.

As shown in FIG. 14, at a time of the completion of the transfer of the image Y(1), the frame sensor 25 is situated near the frame mark 21db of the frame F2 which is provided in the boundary between the frame F2 and the frame F3.

The yellow image Y(1) formed in the frame F1 is an image which is formed from the “m pixels” in the width direction multiplied by the “LNa lines” in the vertical direction.

In addition, with regard to the transfer position of the image Y(1) relative to the intermediate transfer film 21 in the width direction, for example, a position away from the side edge portion 21e by a distance Ha coincides with the right end of the image Y(1).

This transfer position, or the distance Ha, is set as a reference transfer position to be used while the intermediate transfer film 21 is not shifting sideways. To put it more clearly, the distance Ha is a distance which is determined in advance to correspond to the offset amount β obtained when the correction amount DPb obtained and determined by the correction amount determiner 71 is 0 (zero).

In the case where the positron of the intermediate transfer film 21 shifts in the width direction as a result of the sideways shift during the transfer of the yellow image Y(1), the correction amount determiner 71 obtains the correction amount DPb corresponding to the positional shift, based on the light-reception information J2b from the frame sensor 25. Thus, in accordance with the obtained correction amount DPb, the transfer position in the width direction is adjusted so as to offset the positional shift attributable to the sideways shift.

For this reason, the transfer of the yellow image is a first transfer among the transfers using the multiple colors, but not a superposed transfer, the yellow image is transferred onto the reference transfer position regardless of whether or not the intermediate transfer film 21 shifts sideways.

Once the transfer of the yellow image Y(1) shown in FIG. 14 is completed, the CPU 81 brings the thermal head 16 into the release state, and performs a cue operation for a superposed transfer using magenta as the next color, independently, on the ink ribbon 11 and the intermediate transfer film 21.

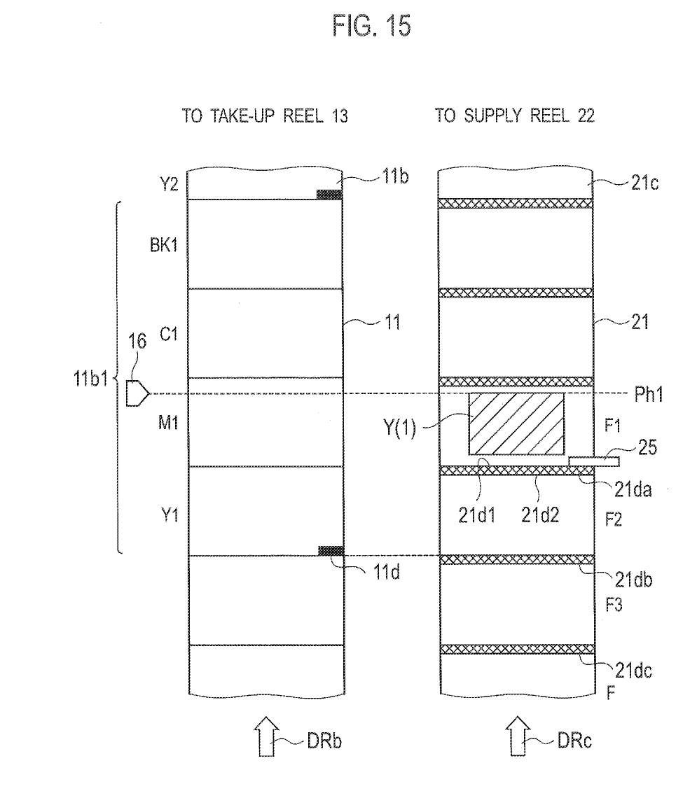

FIG. 15 is a diagram for explaining the cue operation performed for the transfer of the magenta image.

The ink ribbon 11 is reversely conveyed (in the direction indicated with the white arrow DRb), and the press-contact position Ph1 of the thermal head 16 is made to coincide with the transfer start position of the magenta ink layer M1 which is a position near the cyan ink layer C1).

The intermediate transfer film 21 is forwardly conveyed (in the direction indicated with the white arrow DRc), and the press-contact position Ph1 of the thermal head 16 is made to coincide with the transfer start position of the frame F1.

The cue operation performed on the intermediate transfer film 21 for the magenta transfer operation is the same as the previously-described cue operation performed to transfer the yellow ink layer Y1.

In a case where the position of the intermediate transfer film 21 shifts in the width direction as a result of a sideways shift during the transfer of the magenta image M(1), the correction amount determiner 71 obtains the correction amount DPb corresponding to the positional shift, based on the light-reception information J2b from the frame sensor 25. Thus, in accordance with the obtained correction amount DPb, the transfer position in the width direction is adjusted so as to offset the positional shift attributable to the sideways shift. By this adjustment, the magenta image M(1) is transferred onto the reference transfer position as well.

Thereby, the magenta image M(1) is superposed and transferred onto the yellow image Y(1) with virtually no positional shift in the width direction.

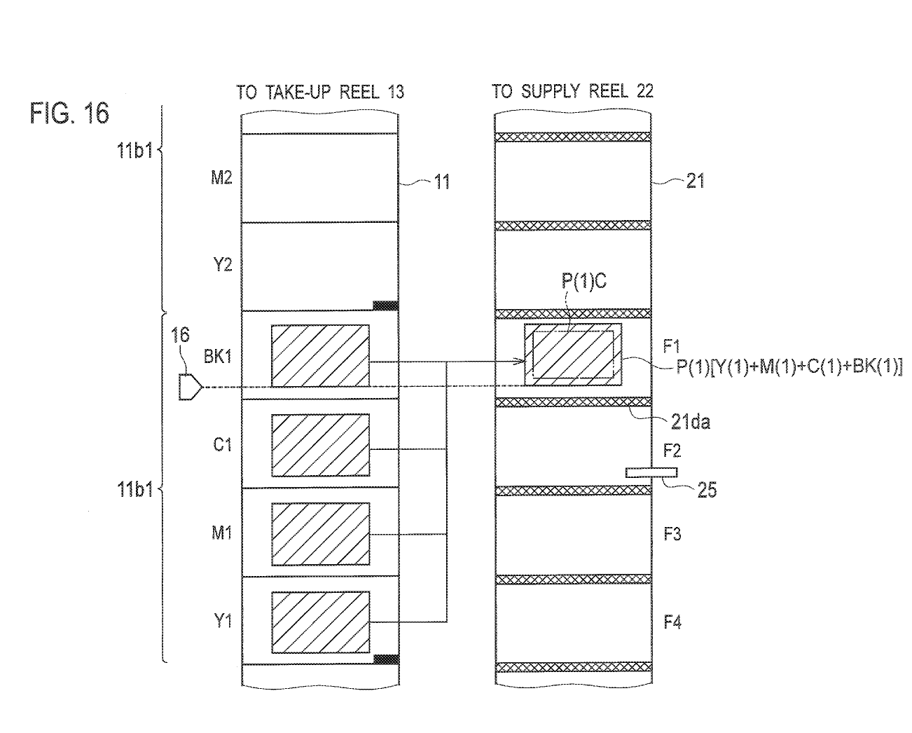

After the superposed transfer of the magenta image M(1), the superposed transfer of each of the cyan image C(1) and the black image BK(1) is similarly performed including the transfer position correction operation. Thereby, a multi-color image P(1) is formed superposing and transferring the four colors onto the frame F1, as shown in FIG. 16. The positions of the thermal head 16 and the frame sensor 25 in FIG. 16 are shown as positions where the thermal head 16 and the frame sensor 25 are situated when the transfer of the black image BK(1) is completed.

For the superposed transfer of the cyan image C(1), and for the superposed transfer of the black image BK(1), the transfer position is corrected based on the light-reception information J2a which is obtained from the cue operation for each transfer.

This enables the superposed transfers using the respective four colors to be performed with their transfer positions controlled with high accuracy, and makes it possible to obtain a highly-accurate intermediate image, which is not misregistered, in the arbitrary frame F.

The intermediate image is retransferred by the retransfer apparatus 52 onto the card 31. No restriction is imposed on the operation timing of the transfer onto the intermediate transfer film 21 or the operation timing of the retransfer onto the card 31. The retransfer may be performed once one intermediate image is formed in one transfer frame F, and before another intermediate image is formed in the next transfer frame F.

Alternatively, the retransfer may be performed such that intermediate images en masse are formed respectively in the multiple transfer frames F; and thereafter, all of the intermediate images, or some selected intermediate images are retransferred.

In the printer PR, the image forming apparatus 51 is capable of stably forming the intermediate images, which are virtually not misregistered, on the intermediate transfer film 21 without being affected by the sideways shift of the intermediate transfer film 21. Thereby, in a case where the intermediate images are transferred onto a retransfer material such as the card 31, the obtained retransferred images are high-quality images which are not misregistered.

Furthermore, in terms of its mechanism, the image forming apparatus 51 uses a conventional film sensor for the line sensor, and an FPGA for the image data transmitter CT1, compared to conventional image forming apparatuses.

The use of these parts only slightly increases costs. For this reason, the image forming apparatus 51 is capable of minimizing the cost increase, and forming a high-resolution image while preventing the transfer images from being misregistered due to the sideways shift.

Moreover, the image forming apparatus 31 detects the positional shift in the width direction attributable of the sideways shift by use of the frame marks 21d originally formed in the intermediate transfer film 21. For this reason, the image forming apparatus 51 is capable of using the intermediate transfer films 21, which is commercially available, as they are, and does not increase costs. Accordingly, the image forming apparatus 51 is highly convenient for the user and the supplier.

The embodiment of the present invention is not limited to the foregoing configuration and procedure. Modifications may be made within a scope not departing from the gist of the present invention.

The image forming apparatus 51 which is installed in the printer PR being combined with the retransfer apparatus 52 has been described. However, the image forming apparatus 51 is not limited to this example.

The image forming apparatus 51 may be combined with a different apparatus. It is a matter of course that the image forming apparatus 51 may be a stand-alone apparatus as an image forming apparatus.

The platen roller 26 and the thermal head 16 only need to be brought into and out of contact with each other in a relative movement. Configuration may be made such that the thermal head 16 is fixed and the platen roller 26 is brought into and out of contact with the thermal head 16.

The controller CT may be provided outside the housing PRa. In a case where the controller CT is provided outside, signals are sent and received between the controller CT and the printer main body inside the housing PRa by wire or by wireless.

The number of heating resistors 16a, or m, used for a transfer image does not necessarily have to satisfy m<n. All of the heating resistors 16a may be used by setting m equal to n.

The frame mark 21d is not limited to the one which completely blocks light. The frame mark 21d and the frame sensor 25 may be chosen such that the light transmissivity of the frame mark 21d is lower than that of the other part of the intermediate transfer film 21 and the frame sensor 25 is capable of detecting the difference between the frame mark 21d and the other part.

The frame mark 21d is not limited to the one which reaches the side edge portions 21e of the intermediate transfer film 21, and the positions of whose mark side end portions 21d3 agree with those of the side edge portions 21e. The frame mark 21d may be provided with the positions of the mark side end portions 21d3 away from the side edge portions 21e by a certain distance.

In this case, the frame sensor 25 may be arranged extending across the mark side end portion 21d3, which is a side end portion closer to the side edge portion 21e of the frame mark 21d.

What is claimed is:

1. An image forming apparatus comprising:
a platen roller;
a thermal head configured to be brought into or out of contact with the platen roller in a relative movement;
an ink ribbon conveyance mechanism configured to convey an ink ribbon including a plurality of color ink layers;
a transfer film conveyance mechanism configured to convey a transfer film on which a plurality of transfer frames are formed at a predetermined pitch in a longitudinal direction and demarcated by frame marks having light transmissivity lower than that of another part of the transfer film;
a line sensor arranged to extend in a width direction of the transfer film across end portions of the frame marks in the width direction; and
a controller configured to, when forming color images on a selected one of the transfer frames by making the ink ribbon conveyance mechanism and the transfer film conveyance mechanism respectively convey the ink ribbon and the transfer film such that the color ink layers on the ink ribbon sequentially face the selected transfer frame on the transfer film, and by bringing the thermal head into press contact with the platen roller with the ink ribbon and the transfer film, interposed in between, adjust positions of the images to be formed on the selected transfer frame, in the width direction based on light-reception information outputted from the line sensor.

2. The image forming apparatus according to claim 1, wherein
when the transfer film is conveyed for a cue operation on the transfer frame,
the controller brings the thermal head and the platen roller into press contact with each other based on the light reception information obtained from a leading edge portion of the corresponding frame mark in a movement direction, and
the controller adjusts the positions of the images in the width direction based on the light-reception information obtained from a tailing edge portion of the frame mark in the movement direction.

3. The image forming apparatus according to claim 1, wherein when any of the frame marks is situated in a position where the frame mark is caught by the line sensor, the thermal head is situated in a cue position of a transfer frame contiguous to the frame mark caught by the line sensor.

4. The image forming apparatus according to claim 1, wherein
the light-reception information is information based on a plurality of light receiving sensors included in the line sensor, and
the controller converts the information based on the light receiving sensors into information based on a plurality of heating resistors included in the thermal head.

5. A retransfer printer comprising:
the image forming apparatus according to claim 1; and
a retransfer apparatus configured to retransfer the images, transferred onto the transfer frame by imageforming apparatus, onto a transfer material.

6. An image forming method comprising:
detecting positions of an end portion of a frame mark in a width direction on a transfer film, on which a plurality of transfer frames are formed at a predetermined pitch in a longitudinal direction, and are demarcated by frame marks having light transmissivity lower than another part of the transfer film, based on light-reception information outputted from a line sensor arranged to extend across the end portion in the width direction; and
adjusting positions of color images to be formed by superposing and transferring a plurality of color ink images onto one of the transfer frames, in the width direction based on the detected positions of the end portion of the frame mark in the width direction.
